(19) United States
(12) Patent Application Publication
(10) Pub. No.: US 2026/0004018 A1
(43) Pub. Date: Jan. 1, 2026

(54) MANAGING DEPENDENCIES THROUGH INTERLINKED DIGITAL TWINS

(71) Applicant: INTERNATIONAL BUSINESS MACHINES CORPORATION, Armonk, NY (US)

(72) Inventors: Christoph RAISCH, Gerlingen (DE); Martin LUMSDON, Haresfield (GB); Mike GHORAISHI, Umea (SE); Saritha ROUTE, Bangalore (IN)

(21) Appl. No.: 18/756,109

(22) Filed: Jun. 27, 2024

(51) Int. Cl. G06F 30/20; G06F 119/18

(52) U.S. Cl. CPC G06F 30/20; G06F 2119/18

(57) ABSTRACT

Computer implemented methods, systems, and computer program products include program code executing on a processor(s) automatically generates, based on historical production data, digital twins, where each digital twin is a digital twin of an entity in the production cycle. The processor(s) obtains a given digital twin associated with a given entity and initiates notarizing the given digital twin by extracting characteristics of the given entity, comparing the characteristics to characteristics of previous instances to identify inconsistencies, compares waste and byproducts of the given entity to prior instances to determine if an output flow for the given entity is smaller than an input flow. Based on determining that the characteristics are comparable and the output flow for the given entity is smaller than the input flow for the given entity, the processor(s) notarizes the given digital twin and stores the notarized given digital twin in a persistent storage.

### BACKGROUND

The present invention relates generally to the field of supply chain optimization and, specifically, to utilizing digital models to improve tracking and authenticity of resources.

Tracking and validating the supply chain components and establishing authenticity is a challenge and is processing resource intensive in part because it ideally would include traceability and provenance tracking at every constituent component level. Presently, tracing at every level is not possible and if it were possible, it would be exhaustive to existing system resources. Because detailed validation is challenging, systems that cannot be validated can be at risk for fraud within the supply chain.

A digital twin is a digital model of an intended or actual real-world physical product, system, or process (a physical twin) that serves as the effectively indistinguishable digital counterpart of the physical counterpart for practical purposes, including but not limited to, simulation, integration, testing, monitoring, and maintenance. A digital twin can persist or exist throughout the entire lifecycle (create, build, operate/support, and dispose) of the physical entity it represents.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided through the provision of a computer-implemented method for securely verifying a production cycle. The method can include: automatically generating, by one or more processors, based on historical production data, digital twins, wherein each digital twin is a digital twin of an entity in the production cycle; at a non-dispositive stage in the production cycle to manufacture a product, obtaining, by the one or more processors, a given digital twin associated with a given entity, wherein at the non-dispositive stage a party is in physical possession of a party, and initiating notarizing the given digital twin, the initiating notarizing comprising: extracting, by the one or more processors, characteristics of the given entity; comparing, by the one or more processors, the characteristics of the given entity to characteristics of previous instances of the given entity in the production cycle to identify inconsistencies; comparing, by the one or more processors, waste and byproducts of the given entity, to prior instances of byproducts and waste for the given entity to determine if an output flow for the given entity is smaller than an input flow for the given entity; and based on determining that the characteristics are comparable within a pre-defined threshold and the output flow for the given entity is smaller than the input flow for the given entity, notarizing the given digital twin, and based on the notarizing, storing, by the one or more processors, the notarized given digital twin in a persistent storage.

Shortcomings of the prior art are overcome, and additional advantages are provided through the provision of a computer program product for securely verifying a production cycle. The computer program product comprises a storage medium readable by a one or more processors and storing instructions for execution by the one or more processors for performing a method. The method includes, for instance: automatically generating, by the one or more processors, based on historical production data, digital twins, wherein each digital twin is a digital twin of an entity in the production cycle, at a non-dispositive stage in the production cycle to manufacture a product, obtaining, by the one or more processors, a given digital twin associated with a given entity, wherein at the non-dispositive stage a party is in physical possession of a party, and initiating notarizing the given digital twin, the initiating notarizing comprising: extracting, by the one or more processors, characteristics of the given entity; comparing, by the one or more processors, the characteristics of the given entity to characteristics of previous instances of the given entity in the production cycle to identify inconsistencies; comparing, by the one or more processors, waste and byproducts of the given entity, to prior instances of byproducts and waste for the given entity to determine if an output flow for the given entity is smaller than an input flow for the given entity, and based on determining that the characteristics are comparable within a pre-defined threshold and the output flow for the given entity is smaller than the input flow for the given entity, notarizing the given digital twin; and based on the notarizing, storing, by the one or more processors, the notarized given digital twin in a persistent storage.

Shortcomings of the prior art are overcome, and additional advantages are provided through the provision of a system for securely verifying a production cycle. The system includes: a memory, one or more processors in communication with the memory, and program instructions executable by the one or more processors via the memory to perform a method. The method includes, automatically generating, by the one or more processors, based on historical production data, digital twins, wherein each digital twin is a digital twin of an entity in the production cycle; at a non-dispositive stage in the production cycle to manufacture a product, obtaining, by the one or more processors, a given digital twin associated with a given entity, wherein at the non-dispositive stage a party is in physical possession of a party, and initiating notarizing the given digital twin, the initiating notarizing comprising: extracting, by the one or more processors, characteristics of the given entity; comparing, by the one or more processors, the characteristics of the given entity to characteristics of previous instances of the given entity in the production cycle to identify inconsistencies; comparing, by the one or more processors, waste and byproducts of the given entity, to prior instances of byproducts and waste for the given entity to determine if an output flow for the given entity is smaller than an input flow for the given entity; and based on determining that the characteristics are comparable within a pre-defined threshold and the output flow for the given entity is smaller than the input flow for the given entity, notarizing the given digital twin; and based on the notarizing, storing, by the one or more processors, the notarized given digital twin in a persistent storage.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a workflow of various aspects performed by the program code (executing on one or more processors) in some embodiments of the present disclosure;

FIG. 3 illustrates a workflow executed in a technical environment and illustrates aspects of both the workflow itself and hardware and/or software comprising the technical environment; the workflow and technical environmental elements illustrate various aspects performed by the program code performed by the program code in some embodiments of the present disclosure;

FIG. 4 illustrates the program code (executing on one or more processors) in some embodiments of the present disclosure generating a digital twin;

FIG. 5 is a workflow of various aspects performed by the program code (executing on one or more processors) in some embodiments of the present disclosure;

FIG. 6 is a workflow of various aspects performed by the program code (executing on one or more processors) in some embodiments of the present disclosure;

FIG. 7 illustrates a workflow executed in a technical environment and illustrates aspects of both the workflow itself and hardware and/or software comprising the technical environment; the workflow and technical environmental elements illustrate various aspects performed by the program code performed by the program code in some embodiments of the present disclosure;

FIG. 8 illustrates a workflow executed in a technical environment and illustrates aspects of both the workflow itself and hardware and/or software comprising the technical environment; the workflow and technical environmental elements illustrate various aspects performed by the program code performed by the program code in some embodiments of the present disclosure;

FIG. 9 illustrates a workflow executed in a technical environment and illustrates aspects of both the workflow itself and hardware and/or software comprising the technical environment; the workflow and technical environmental elements illustrate various aspects performed by the program code performed by the program code in some embodiments of the present disclosure; and

FIG. 10 illustrates a workflow executed in a technical environment and includes a portion of a manufacturing cycle and supply chain in which an Nth customer and a Supplier (N+1/N−1) is a participant.

### DETAILED DESCRIPTION

The examples herein include computer-implemented methods, computer program products, and computer systems where program code executing on one or more processors generates and/or utilizes agents to manage supply-chain dependencies by utilizing interlinked digital twins. In some examples, these digital twins are persisted in a distributed data store and include a minimal set of components. Additionally, the program code can utilize agents and a novel notary-based method to check for consistency in the supply chain. In the examples discussed herein, an agent is a computer resource that serves with the computer-implemented methods, computer program products, and computer systems described as a representation of an individual or entity acting on behalf of an auditor.

As aforementioned, a digital twin is a digital model of an intended or actual real-world physical product, system, or process (a physical twin) that serves as the effectively indistinguishable digital counterpart of it for practical purposes. In general, because information is granular, a digital twin representation can be generated by program code based on the program code utilizing (and implementing) value-based use cases. By implementing a digital twin, one can model and simulate an entity's entire lifecycle to be modeled and simulated. A digital twin of an existing entity can be used in real-time and regularly synchronized with a corresponding physical system. Products refer to items or goods produced or consumed in a supply chain.

Examples herein include computer-implemented methods, computer systems, and computer program products where program code executing on one or more processors manages supply-chain dependencies in a physical system through interlinked digital twins, persisted in a distributed data store. The examples herein are directed to a practical application at least because program code in these examples can track and validate supply chain components and establish authenticity of these components, accurately and efficiently, at every stage without taxing human and/or computing system resources.

Not only do the examples herein address a known practical need, the approach is inextricably tied to computing because the examples herein address a known issue (e.g., validating supply chain components and establishing the authenticity of these components), that cannot be effectively addressed without utilizing computer technology because the level of granularity to validate and authenticate a supply chain at every stage would utilize resources and time beyond what could be implemented and still enable the supply chain and the systems that surround it to operate within their expected performance for the supply chain to function. The examples herein port the supply chain to a computing platform and by inextricably tying the supply chain to computing, including by utilizing the digital twin, the examples herein can effectively address supply chain issues in a system that does not include the fraud risks in approaches that are not inextricably tied to computing.

The examples herein provide significantly more than existing supply chain management systems. As will be described herein, not only do the examples herein solve existing supply chain management system problems by providing a solution that includes granularity that cannot be achieved in current systems due to time and computing constrains, but also, the examples herein extend the base functionality of both digital twins and agents, which are included in certain of the examples escribed, with program code that performs a notary-based method of checking for consistency in a supply chain. Thus, not only is the practical application to which the computing technology herein applied novel, but the extension of the digital twin technology itself provides significantly more than existing uses of digital twinning.

In the examples herein computer-implemented methods, computer program products, and computer systems comprise program code executed on one or more processors that manage supply-chain dependencies. As will be discussed in greater detail herein, in some of these examples, the program code associates products processed by a processing entity with associated digital twins. A processing entity can be understood to be an individual and/or system and/or factory that processes items and/or raw materials into final products. Processing entities differ from shipping agencies, warehouses, and other transitory entities that do not alter the state of the goods. The program code enables the processing entity to specify, to an auditor, a production relationship between precursor material, manufacturing (e.g., steps, processes), and final product so that the auditor can notarize the digital twins. Program code comprising an agent (e.g., an auditor agent) can augment the digital twins with non-production related characteristics, including but not limited to associated resource consumption, Corporate Sustainability Reporting Directive (CSRD) and can certify the digital twins' content with an automated notarization step. Characteristics can refer to a physical characteristic, a digital characteristic, a feature and/or a quality belonging to a person, place, or thing. The program code comprising the agent can verify consistency of the resource characteristics. The characteristics can include, but are not limited to, sum of materials, energy, time (money), and/or original-linkages to previous digital twins. The program code in these examples can store the inter-linked digital twins in a persistent datastore. The persistent datastore can comprise a database that includes records that are stored for periods based on legal requirements (e.g., 30 year, 120 years, for the life of a system, etc.). In some examples, the persistent database can be maintained by a custodian entity or registrar.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

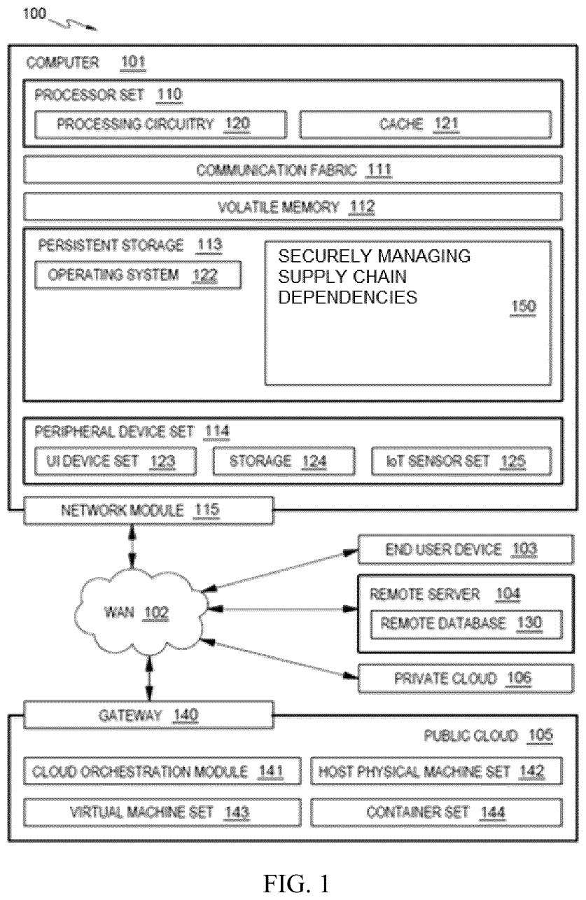

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block 150 for securely managing supply chain dependencies. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Tracking and validating the supply chain components and establishing authenticity is a challenge and is resource intensive and traceability and provenance tracking at every constituent component level is an unsolved problem, leaving supply chains open to fraud. The examples herein address these know issues and effectively and efficiently manage supply chains by utilizing notary agents with interlinked digital twins.

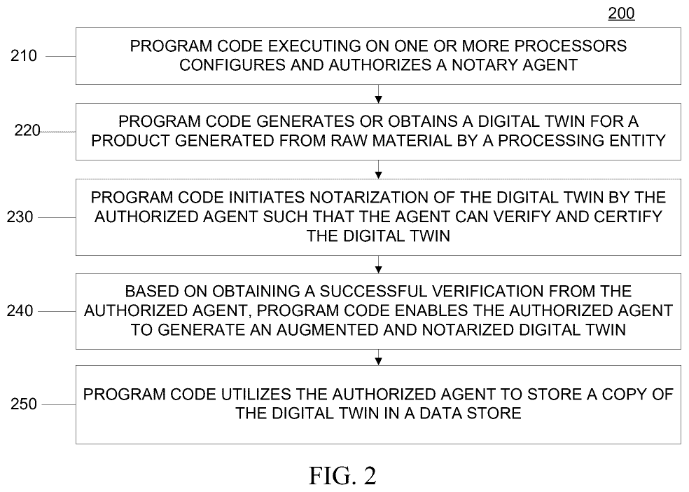

FIG. 2 is a workflow 200 that illustrates various aspect of some of the examples herein. In this example, program code executing on one or more processors configures and authorizes a notary agent (210). The program code generates or obtains a digital twin for a product generated from raw material by a processing entity (220). The program code initiates notarization of the digital twin by the authorized agent such that the agent can verify and certify the digital twin (230). Based on obtaining a successful verification from the authorized agent, the program code enables the authorized agent to generate an augmented and notarized digital twin (240). The program code utilizes the authorized agent to store a copy of the digital twin in a data store (250). In some examples, the data store is a persistent data store managed by a custodian.

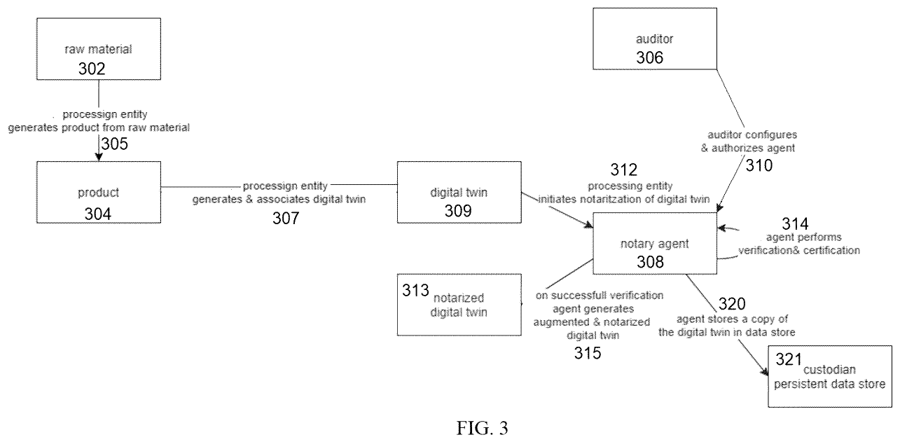

FIG. 3 provides additional details to highlight the relationships of various entities that affect the workflow 200 of FIG. 2, and the functionality of the program code executed by one or more processors in the examples herein. In this non-limiting example, program code executing on one or more processors is separated into different modules. Various examples can utilize different numbers of modules to implement portions of a workflow (e.g., FIG. 2, 200). In this example, a processing entity utilizes raw material 302 to generate a product 304 (305). In this example, program code comprising an auditor 306 (and/or controlled by an entity that is an auditor) configures and authorized agent 308 (which can also be understood as a notary agent) (310). In this example, program code comprising (and/or controlled by) a processing entity generates a digital twin and associates a digital twin 309 with the product (307). Program code comprising (and/or controlled by) the processing entity initiates (e.g., triggers) program code comprising the notary agent 308 to notarize the digital twin (312). The program code comprising the agent verifies and certifies the digital twin (314). Based in verifying the digital twin, the program code comprising the agent generates a notarized digital twin 313 (e.g., a digital twin augmented with the verification) (315). The program code comprising the agent stores a copy of the digital twin 309, 313, in a persistent datastore 321, which can be managed by a custodian.

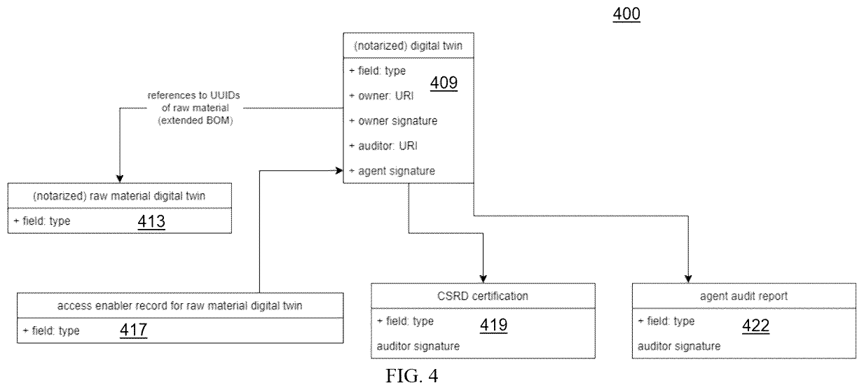

FIG. 4 illustrates a construct 400 for a digital twin in a context of some examples herein. As illustrated in FIG. 4, the digital twin 409 (which can be notarized by an agent (e.g., FIG. 3, 308)) includes a field type, a Uniform Resource Identifier (URI) to indicate an owner. AS understood by one of skill in the art, a URI is a unique sequence of characters that identifies a logical or physical resource, an owner signature, a URI to indicator the auditor, and an agent signature (e.g., when notarized). In these examples, the (notarized) digital twin 409 can include references to Universal Unique Identifiers (UUIDs) of raw materials (e.g., materials in a bill of material (BOM). A UUIS is a 128-bit value used to uniquely identify an object or entity on the internet while a BOM is a comprehensive list of parts, items, assemblies, subassemblies, intermediate assemblies, documents, drawings, and other materials utilized to create a product. As such the digital twin construct 400 can include identifiers for (notarized) raw material digital twin 413, which can include a type field. The references to UUIDs of raw materials is an advantage provided in the examples herein when compared to existing digital twins.

Program code executing on one or more processors in the examples herein can provide access to the (notarized) digital twin 409 for purposes including a (successful) buyer transaction. The transaction can be enabled by the program code based on the digital twin 409 comprising an agent signature. The digital twin construct 400 can comprise a record 417 which enables (based on the program code generating the record 417) access to both the (notarized) digital twin 409 and the notarized) raw material digital twin 413.

In the examples herein, The (notarized) digital twin 409 can also include a CSRD certification 419 as part of the digital twin construct 400. The CSRD certification 419 can include a type field as well as an auditor signature. The program code can utilize the (notarized) digital twin 409 to generate the CSRD certification 419. In the digital twin construct 400, the program code can generate an agent auditor report 422 that include a type field as well as an auditor signature. The agent audit report and the ability of the program code to generate the report as part of the digital twin construct 400 is also an aspect that provides as advantage over existing digital twins and digital twin applications.

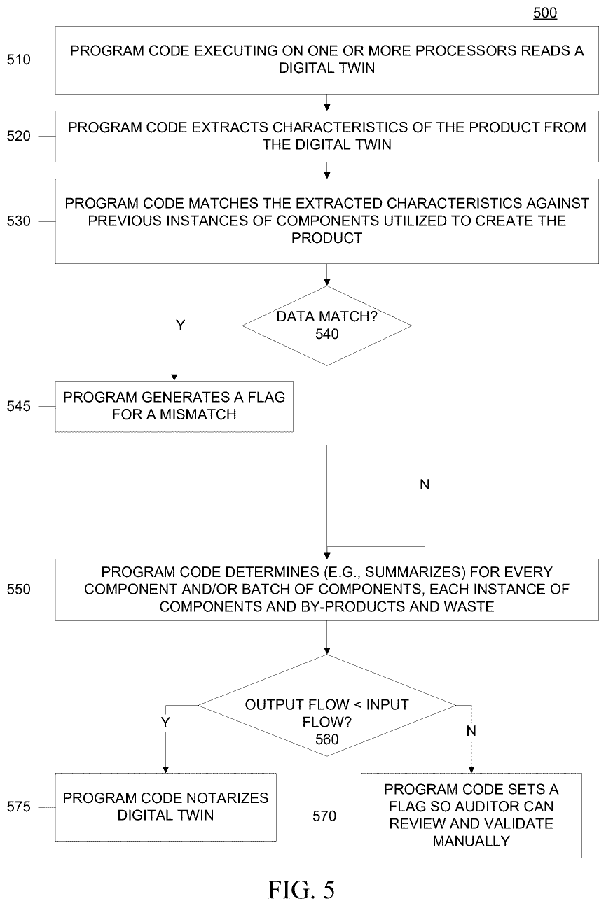

FIG. 5 is a workflow 500 performed by program code executing on one or more processors in the examples herein in which the program code verifies consistency of resource characteristics. To illustrate a practical application of the examples herein, a product that can be utilized as a non-limiting example is a bicycle seat. This bicycle seat is an non-limiting example as the workflow 500 of FIG. 5 can be applied to any typical supply chain process in manufacturing.

In the workflow 500 of FIG. 5, program code executing on one or more processors reads a digital twin (510). The program code extracts characteristics of the product (e.g., a bicycle seat) from the digital twin, including but not limited to energy, time, money, and/or a sum of materials for a product (520). The program code matches the extracted characteristics against previous instances of components utilized to create the product (530). Returning to the example of the bicycle seat, components can include, but are not limited to leather, steel, a frame, and/or hardware, such as nuts and/or bolt. The program code checks the extracted characteristics against each component and requests a validation by an auditor for each component if there is not a match (540). This check is a data check, and in some examples, the program code can generate a flag if there is a mismatch (545). An auditor can obtain the flag (e.g., via an application programming interface (API)), and manually validate the processing. In some examples, an auditor (an entity which can be an automated process) can delay notarization until the program code successfully completes a flow check. If the data matches, the program code does not generate a flag. The program code determines (e.g., summarizes) for every component and/or batch of components, each instance of the components and the by-products and waste associated with the processing (550). The program code checks the flow (as aforementioned) to determine if the output is smaller than the input flow of the components (560). If the program code determines that the output is not smaller than the components, the program code alerts the auditor (e.g., via a flag, e.g., via an API), so that the auditor can validate the process manually (570). If the program code determined that the output is smaller than the input flow of the components (e.g., within a standard pre-configured margin of error and/or within standard pre-configured limits), the program code automatically notarizes the digital twin to verify the consistency of the resource characteristics (e.g., via the agent) (575).

In the workflow 500, the program code enforces the veracity and efficiency of the process in various illustrated aspects, including but not limited to checking the data (540), delaying notarization until after the program code competes the flow check, summing up across the components (550), and checking the flow (560). In performing these aspects, program code in the examples herein can flag fraudulent actors or players and establish the veracity of a stack of digital twins and a stack of stacks across the components that make up the product at any point during a production cycle. Thus, the program code securely manages supply chain dependencies. In these examples, a product is an accumulation of the previous components and thus, the program code can validate the product progressively by validating each previous stage in production. By-product and waste management is also provided in this workflow 500, including by checking the data (540) and checking the flow (560). The program code can track the waste and byproducts via the digital twin of the BOM, thus the program code can validate the authenticity of the waste information.

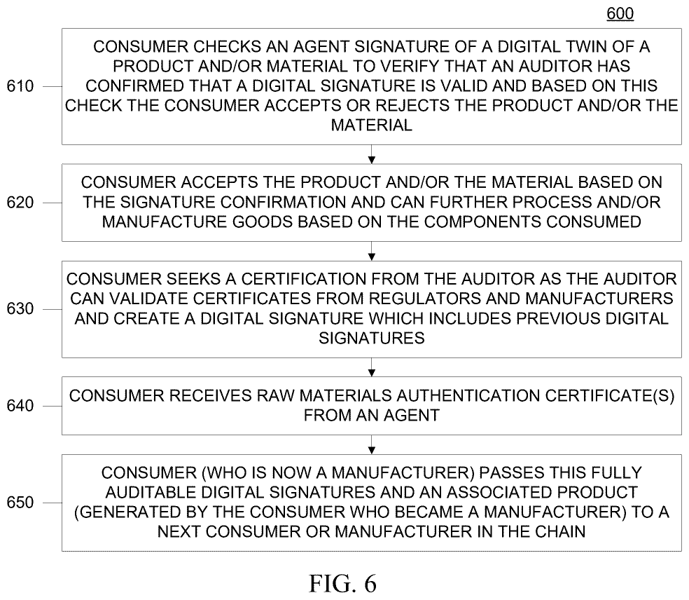

FIG. 6 is a workflow 600 that illustrates how program code executing on one or more processors in examples herein can track and validate supply chain components. The workflow 600 illustrates how the examples herein are directed to a practical application at least because the authorization of a digital twin by the program code is consumed in a real-life scenario. For example, a consumer can check an agent signature of a digital twin of a product and/or material to verify that an auditor has confirmed that a digital signature is valid and based on this check the consumer can accept or reject the product and/or the material (610). If the consumer accepts the product and/or the material based on the signature confirmation, the consumer can further process and/or manufacture goods based on the components consumed (620). Because this consumer is now engaged in the processing and/or manufacturing of goods, the consumer becomes a manufacturer of new goods and/or new components and can provide a certificate of authentication down the supply chain. Prior to providing the certificates, the consumer seeks a certification from the auditor as the auditor can validate certificates from regulators and manufacturers and create a digital signature which includes previous digital signatures (630). The consumer receives raw materials authentication certificate(s) from an agent (640). This consumer (who is now a manufacturer) passes this fully auditable digital signatures and an associated product (generated by the consumer who became a manufacturer) to a next consumer or manufacturer in the chain (650).

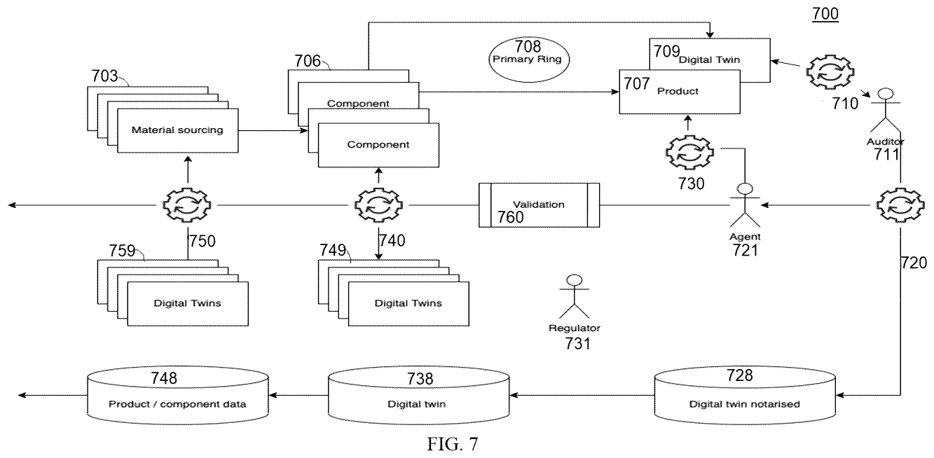

FIG. 7 illustrates an implementation 700 of various aspects of some examples herein in a technical environment. Among the aspects that are illustrated in FIG. 7, FIG. 7 focuses on certain automated aspects that are enabled and/or completed by program code executing on one or more processors without manual intervention. As will be discussed in greater detail below, the workflow 700 illustrates how program code executed by one or more processors retrieves and matched product information to validate a digital signature (710), notarizes and accesses an authentication (720), accesses an authentication based on matching product specifications with a digital twin (730), back traces to a prior product component to access an authentication based on matching product specifications with a digital twin (740), and back traces to a prior material component to access an authentication based on matching product specifications with a digital twin (750).

As illustrated in FIG. 7, program code generates digital twins for all products and components in a manufacturing or supply chain. Materials are sourced 703 to create components 706, which are utilized to create a product 707 (in the primary ring 708). The program code generates digital twins, including digital twins for each sourced material 759, digital twins for each component 749, and a digital twin for the product 709. As discussed above, the program code notarizes a digital twin 709 based on the program code retrieving and matching product information and hence, validating a digital signature of an auditor 711 (710). The program code can automatically notarize a digital twin and access authentications (720). To enable this access the program code stores inter-linked digital twins in a persistent datastore which can include storage for notarized digital twins 728, storage for digital twins 738, and storage for product and component data 748.

An agent 721 (e.g., utilizing an API) can access the authenticated and/or notarized records in the persistent datastore. As illustrated in the workflow 500 of FIG. 5, the program code can generate a flag if there is a mismatch related to a product 707 at any stage in processing (545). Returning to FIG. 7, when the program code checks the flow (e.g., FIG. 5, 560), the program code can flag findings outside of an expected level and thus, the program code enabled an agent 72 to manually authenticate these findings. The program code automatically accesses the authentication-based matching by the program code of product 707 specifications and a digital twin 709 (730). The authentication-based matching by the program code can be backed to a component 706 level (740) as well as a sourced material 703 level (750). Because the program code generates digital twins at all the levels of productions, the program code can consistency track and validate (760) the production cycle throughout production (the supply chain). This process provides transparency to regulators 731. Thus, the program code securely manages supply chain dependencies.

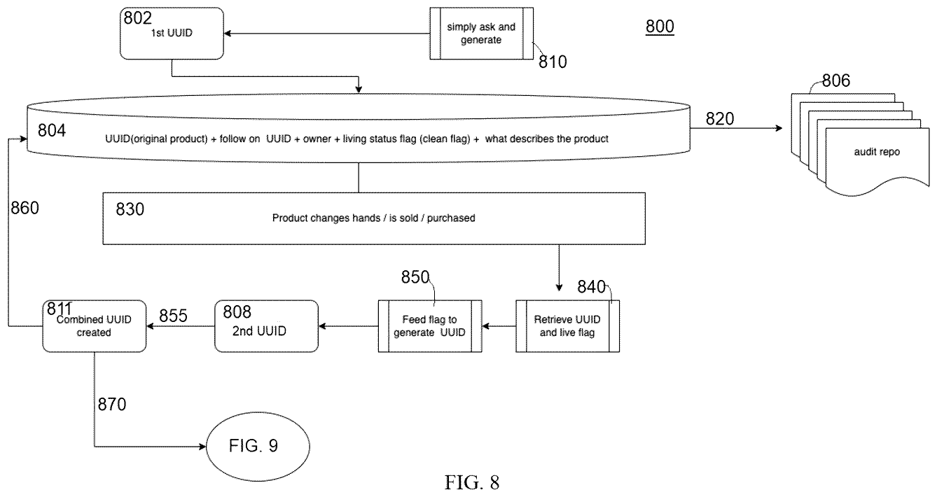

FIG. 8 illustrate portions of a process 800, 900, and 1000 for implementing aspects of the examples herein in a manufacturing cycle, hence illustrating how aspects of the examples are directed to a practical application. FIGS. 8-10 also illustrate aspects of the technical environment into which certain of the aspects of the examples herein can be implemented. Throughout these workflows 800 900 1000 the program code utilizes digital twins for raw materials, components, and the product itself, to verify the efficacy of the product cycle and hence securely managing supply chain dependencies.

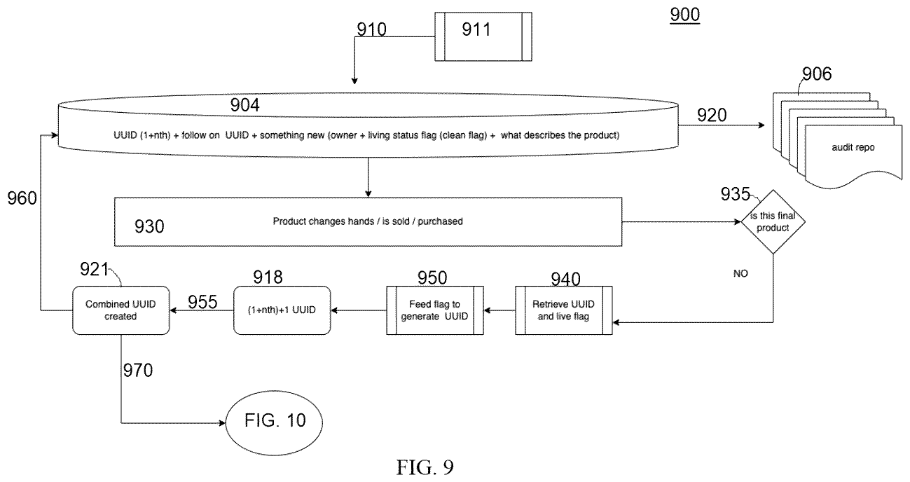

In FIG. 8, the program code receives a request to generate a first UUID 802 (810). The program code generates audit reports 806 (820) throughout processing as the program code tracks (in a data store 804) aspects including, but not limited to, the UUID of the original product, any follow on UUID, the product owner, the living status flag (clean flag), and descriptors of the product. When the program code obtains data indicating that product has changed hands, was sold, and/or was purchased (830), the program code retrieves the UUID and the live flag (840) and utilizes the flag to generate a second UUID 808 (850). The program code combines the UUIDs into a combined UUID 811 (855) and saves the combined UUID 811 in the persistent storage 804. The process 800 progresses to FIG. 9 (870).

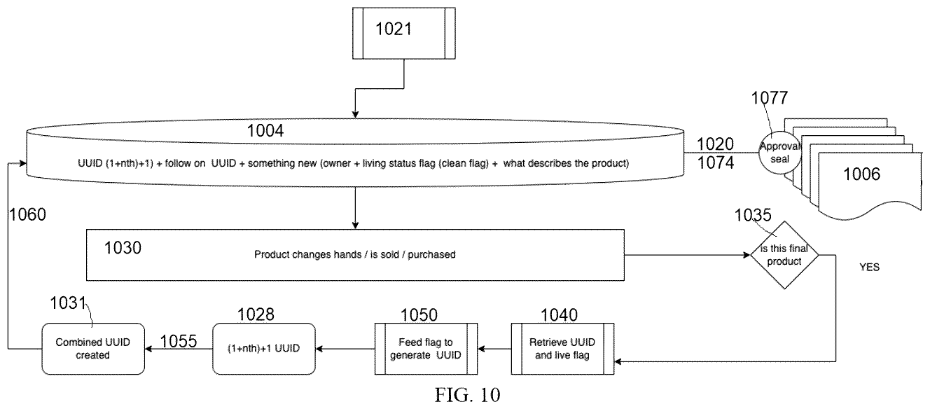

FIG. 9 includes a workflow 900 that is similar to FIG. 8, as illustrated in FIG. 6, a consumer can become a manufacturer. Thus, the workflow 900 commences when the program code retains the combined UUID 811 911 in the storage 904 (860, 910). The program code continues to generate audit reports 906 (920) throughout processing as the program code tracks (utilizing digital twins illustrated in FIG. 7) (in a data store 904) aspects including, but not limited to, the combined UUID 911, 821 from the last consumer, any follow on UUID, the product owner, any new living status flag (clean flag), and descriptors of the product. When the program code obtains data indicating that product (at a different stage in the manufacturing cycle given the new consumer) has changed hands, was sold, and/or was purchased (930), the program code first determines if the product is final (935). If the product is not final, the program code retrieves the current UUID and the live flag (940) and utilizes the flag to generate an additional UUID 918 (850) The additional UUID is illustrated as (1+nth)+1 UUID to show that the workflow 900 can continue until a product is final. The program code combines the UUIDs into a combined UUID 921 (955) and saves the (new) combined UUID 921 in the persistent storage 904. The process 900 progresses to FIG. 10 (970).

FIG. 10 illustrates the combined workflows of FIGS. 8-10 at a point when the product is final. Hence, the workflow 1000 of FIG. 10 includes a portion of the manufacturing cycle and supply chain in which an Nth customer and a Supplier (N+1/N−1) is a participant. Thus, the workflow 1000 commences when the program code retains the combined UUID 921 1011 in the storage 1004 (960, 1010). The program code continues to generate audit reports 1006 (1020) throughout processing. Based on the program code determining that there is a match at this stage between anticipated characteristics and actual characteristics (based on past cycles), the program code can generate an approval seal 1077 which the program code stores in the storage (1074). The approval seal 1077 can indicate to the program code that the product is final. The program code retains the progress of the manufacturing cycle in the storage 1004, including but not limited to, the combined UUID 921, 1011 from the last consumer, any follow on UUID, the product owner, any new living status flag (clean flag), and descriptors of the product. When the program code obtains data indicating that product (at a different stage in the manufacturing cycle given the new consumer) has changed hands, was sold, and/or was purchased (1030), the program code first determines if the product is final (1035). The workflow 900 of FIG. 9 illustrates actions performed by the program code in examples herein based on the program code determining that the product is not final. Based on determining that the product is final, in this workflow 1000, the program code retrieves the current UUID and the live flag (1040) and utilizes the flag to generate an additional UUID 1028 (1050). The additional UUID is illustrated as (1+nth)+1 UUID to as the workflow 1000 continues until a product is final. The program code combines the UUIDs into a combined UUID 1031 (1055) and saves the (new) combined UUID 1031 in the persistent storage 1004 (1060). As discussed earlier, the program code can implement the approval seal 1077 at this stage as well given the program code bas established the finality of the product (1074).

Although various embodiments are described above, these are only examples. For example, reference architectures of many disciplines may be considered, as well as other knowledge-based types of code repositories, etc., may be considered. Many variations are possible.

The examples herein include computer-implemented methods, computer systems, and computer program products, where program code executing on one or more processors automatically generates, based on historical production data, digital twins, wherein each digital twin is a digital twin of an entity in the production cycle. At a non-dispositive stage in the production cycle to manufacture a product, the program code obtains a given digital twin associated with a given entity, where at the non-dispositive stage a party is in physical possession of a party, The program code initiates notarizing the given digital twin which includes: extracting characteristics of the given entity, comparing the characteristics of the given entity to characteristics of previous instances of the given entity in the production cycle to identify inconsistencies, comparing waste and byproducts of the given entity, to prior instances of byproducts and waste for the given entity to determine if an output flow for the given entity is smaller than an input flow for the given entity, and based on determining that the characteristics are comparable within a pre-defined threshold and the output flow for the given entity is smaller than the input flow for the given entity, notarizing the given digital twin. Based on the notarizing, the program code stores the notarized given digital twin in a persistent storage.

In some examples, each entity is selected from the group consisting of: a raw material that comprises a component, the components that comprises the product, and the product.

In some examples, the program code initiates notarizing the given digital twin also by based on determining that the characteristics are not comparable within a pre-defined threshold, automatically flagging, inconsistencies identified in the comparing. The program code also provides the inconsistencies to a user via an application programming interface.

In some examples, the program code obtains a manual verification. Based on obtaining the manual verification, notarizing, notarizing the given digital twin.

In some examples, the program code obtains the manual verification from an authenticated agent.

In some examples, the program code initiates notarizing the given digital twin by: based on determining that the output flow for the given entity is not smaller than the input flow for the given entity, automatically flagging, inconsistencies identified in the comparing, and providing the inconsistencies to a user via an application programming interface.

In some examples, the characteristics are selected from the group consisting of: energy, time, money, and sum of material.

In some examples, the program code associates a universal unique identifier with the given digital twin.

In some examples, the program code determines that the party transmitted the given entity to another party. Based on the determining, the program code updates the notarized digital twin with another universal unique identifier. The program code stores the updated digital twin in the persistent storage.

In some examples, at a stage in the production cycle, the program code obtains the updated given twin associated with another entity and at the non-dispositive stage a party is in physical possession of the other party. The program code initiating notarizing the updated given digital twin by: extracting characteristics of the other entity, comparing the characteristics of the other entity to characteristics of previous instances of the other entity in the production cycle to identify inconsistencies, comparing waste and byproducts of the other entity, to prior instances of byproducts and waste for the other entity to determine if an output flow for the other entity is smaller than an input flow for the other entity, and based on the program code determining that the characteristics are comparable within a pre-defined threshold and the output flow for the other entity is smaller than the input flow for the other entity, notarizing the updated given digital twin; and based on the program code notarizing, storing the notarized updated given digital twin in the persistent storage.

In some examples, the given entity and the other entity comprise the product at different points in the production cycle.

In some examples, the program code determines if the other entity is the product.

In some examples, based on determining that the other entity is the product, the program code stores the notarized given digital twin in the persistent storage.

In some examples, based on determining that the other entity is not the product, the program code again updates the updated notarized digital twin with another universal unique identifier. The program code stores the again updated notarized digital twin in the persistent storage.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of securely verifying a production cycle, the method comprising:
automatically generating, by one or more processors, based on historical production data, digital twins, wherein each digital twin is a digital twin of an entity in the production cycle;
at a non-dispositive stage in the production cycle to manufacture a product, obtaining, by the one or more processors, a given digital twin associated with a given entity, wherein at the non-dispositive stage a party is in physical possession of a party, and initiating notarizing the given digital twin, the initiating notarizing comprising:
extracting, by the one or more processors, characteristics of the given entity;
comparing, by the one or more processors, the characteristics of the given entity to characteristics of previous instances of the given entity in the production cycle to identify inconsistencies;
comparing, by the one or more processors, waste and byproducts of the given entity, to prior instances of byproducts and waste for the given entity to determine if an output flow for the given entity is smaller than an input flow for the given entity; and
based on determining that the characteristics are comparable within a pre-defined threshold and the output flow for the given entity is smaller than the input flow for the given entity, notarizing the given digital twin; and
based on the notarizing, storing, by the one or more processors, the notarized given digital twin in a persistent storage.

2. The computer-implemented method of claim 1, wherein each entity is selected from the group consisting of: a raw material that comprises a component, the components that comprises the product, and the product.

3. The computer-implemented method of claim 1, initiating notarizing the given digital twin further comprising:
based on determining that the characteristics are not comparable within a pre-defined threshold, automatically flagging, by the one or more processors, inconsistencies identified in the comparing; and
providing, by the one or more processors, the inconsistencies to a user via an application programming interface.

4. The computer-implemented method of claim 3, further comprising:
obtaining, by the one or more processors, a manual verification; and
based on obtaining the manual verification, notarizing, by the one or more processors, notarizing the given digital twin.

5. The computer-implemented method of claim 4, wherein the obtaining is from an authenticated agent.

6. The computer-implemented method of claim 1, initiating notarizing the given digital twin further comprising:
based on determining that the output flow for the given entity is not smaller than the input flow for the given entity, automatically flagging, by the one or more processors, inconsistencies identified in the comparing; and
providing, by the one or more processors, the inconsistencies to a user via an application programming interface.

7. The computer-implemented method of claim 1, wherein the characteristics are selected from the group consisting of: energy, time, money, and sum of material.

8. The computer-implemented method of claim 1, further comprising:
associating, by the one or more processors, a universal unique identifier with the given digital twin.

9. The computer-implemented method of claim 8, further comprising:
determining, by the one or more processors, that the party transmitted the given entity to another party;
based on the determining, updating, by the one or more processors, the notarized digital twin with another universal unique identifier; and
storing, by the one or more processors, the updated digital twin in the persistent storage.

10. The computer-implemented method of claim 9, further comprising:
at a stage in the production cycle, obtaining, by the one or more processors, the updated given twin associated with another entity, wherein at the non-dispositive stage a party is in physical possession of the other party, and initiating notarizing the updated given digital twin, the initiating notarizing comprising:
extracting, by the one or more processors, characteristics of the other entity;
comparing, by the one or more processors, the characteristics of the other entity to characteristics of previous instances of the other entity in the production cycle to identify inconsistencies;
comparing, by the one or more processors, waste and byproducts of the other entity, to prior instances of byproducts and waste for the other entity to determine if an output flow for the other entity is smaller than an input flow for the other entity; and
based on determining that the characteristics are comparable within a pre-defined threshold and the output flow for the other entity is smaller than the input flow for the other entity, notarizing the updated given digital twin; and
based on the notarizing, storing, by the one or more processors, the notarized updated given digital twin in the persistent storage.

11. The computer-implemented method of claim 10, wherein the given entity and the other entity comprise the product at different points in the production cycle.

12. The computer-implemented method of claim 11, further comprising:
determining, by the one or more processors, if the other entity is the product.

13. The computer-implemented method of claim 12, further comprising:
based on determining that the other entity is the product, storing, by the one or more processors, the notarized given digital twin in the persistent storage.

14. The computer-implemented method of claim 13, further comprising:
based on determining that the other entity is not the product, again updating, by the one or more processors, the updated notarized digital twin with another universal unique identifier; and
storing, by the one or more processors, the again updated notarized digital twin in the persistent storage.

15. A computer system for securely verifying a production cycle, the computer system comprising:
a memory; and
one or more processors in communication with the memory, wherein the computer system is configured to perform a method, said method comprising:
automatically generating, by the one or more processors, based on historical production data, digital twins, wherein each digital twin is a digital twin of an entity in the production cycle;
at a non-dispositive stage in the production cycle to manufacture a product, obtaining, by the one or more processors, a given digital twin associated with a given entity, wherein at the non-dispositive stage a party is in physical possession of a party, and initiating notarizing the given digital twin, the initiating notarizing comprising:
extracting, by the one or more processors, characteristics of the given entity;
comparing, by the one or more processors, the characteristics of the given entity to characteristics of previous instances of the given entity in the production cycle to identify inconsistencies;
comparing, by the one or more processors, waste and byproducts of the given entity, to prior instances of byproducts and waste for the given entity to determine if an output flow for the given entity is smaller than an input flow for the given entity; and
based on determining that the characteristics are comparable within a pre-defined threshold and the output flow for the given entity is smaller than the input flow for the given entity, notarizing the given digital twin; and
based on the notarizing, storing, by the one or more processors, the notarized given digital twin in a persistent storage.

16. The computer system of claim 15, wherein each entity is selected from the group consisting of: a raw material that comprises a component, the components that comprises the product, and the product.

17. The computer system of claim 16, initiating notarizing the given digital twin further comprising:
based on determining that the characteristics are not comparable within a pre-defined threshold, automatically flagging, by the one or more processors, inconsistencies identified in the comparing; and
providing, by the one or more processors, the inconsistencies to a user via an application programming interface.

18. The computer system of claim 17, further comprising:
obtaining, by the one or more processors, a manual verification; and
based on obtaining the manual verification, notarizing, by the one or more processors, notarizing the given digital twin.

19. The computer system of claim 17, wherein the obtaining is from an authenticated agent.

20. A computer program product for securely verifying a production cycle, the computer program product comprising:
one or more computer readable storage media and program instructions collectively stored on the one or more computer readable storage media readable by at least one processing circuit to:
automatically generate, based on historical production data, digital twins, wherein each digital twin is a digital twin of an entity in the production cycle;
at a non-dispositive stage in the production cycle to manufacture a product, obtain a given digital twin associated with a given entity, wherein at the non-dispositive stage a party is in physical possession of a party, and initiate notarizing the given digital twin, the initiating notarizing comprising:
extract characteristics of the given entity;
compare the characteristics of the given entity to characteristics of previous instances of the given entity in the production cycle to identify inconsistencies;
compare waste and byproducts of the given entity, to prior instances of byproducts and waste for the given entity to determine if an output flow for the given entity is smaller than an input flow for the given entity; and
based on determining that the characteristics are comparable within a pre-defined threshold and the output flow for the given entity is smaller than the input flow for the given entity, notarize the given digital twin; and
based on the notarizing, store the notarized given digital twin in a persistent storage.
